(19) United States
(12) Patent Application Publication
(10) Pub. No.: US 2014/0280017 A1
(43) Pub. Date: Sep. 18, 2014

(54) AGGREGATIONS FOR TRENDING TOPIC SUMMARIZATION

(71) Applicant: MICROSOFT CORPORATION, Redmond, WA (US)

(72) Inventors: Sameer Indarapu, Sunnyvale, CA (US); Vasilis Kandylas, Sunnyvale, CA (US); Anirudh Koul, Sunnyvale, CA (US); Omar Alonso, Redwood Shores, CA (US)

(73) Assignee: MICROSOFT CORPORATION, Redmond, WA (US)

(21) Appl. No.: 13/795,204

(22) Filed: Mar. 12, 2013

(51) Int. Cl. G06F 17/30

(52) U.S. Cl. CPC G06F 17/30864
USPC 707/711; 707/706; 709/204

(57) ABSTRACT

Architecture that enables extraction of pieces of content from the Internet, social networks, in particular, and/or of a user's immediate circle of friends and family, where the content relates to trending topics of those networks as relevant to a search query. The content effectively summarizes a trending topic (e.g., of a single social network or across multiple social networks). The summary can be characterized by different content types, such as images only, text only, and so on. The extracted content can then be presented in a number of different ways such as in a display that visually rotates through the different types of content, such as trending images, summarizing updates, and trending webpages, for example. Another technique for presentation of the extracted social content can be as user-selectable “hotspots” on a page or desktop, and which can display the trending topic summaries.

### BACKGROUND

The detection of “hot” or “trending” topics on the Internet is a desired feature for search engines. Search engines display these topics and typically show news articles as results for these topics. However, there is non-trivial content about these topics in social networks that is not captured by web documents and news articles.

Current attempts to solve this problem involve showing posts made on social networks as part of the search results for trending queries. However, this is a non-representative and frequently uninteresting view of the activity on social networks related to that topic, since a small set of individual updates (which are typically shown) do not convey the true activity or are not interesting to a searcher.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables the extraction of pieces of content from the Internet, social networks, in particular, and/or of a user's immediate circle of friends and family, where the content relates to trending topics of those networks as relevant to a search query. The content effectively summarizes a trending topic (e.g., of a single social network or across multiple social networks). The summary can be characterized by different content types, such as images only, text only, and so on.

The extracted content can then be presented in a number of different ways such as in a display that visually rotates through the different types of content, such as trending images, summarizing updates, and trending webpages, for example. Another technique for presentation of the extracted social content can be as user-selectable “hotspots” on a page or desktop, and which can display the trending topic summaries.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system that further includes indexing and location activity processing.

FIG. 3 illustrates an exemplary user interface where a trend summary is represented by content being cycled in a search engine results page.

FIG. 4 illustrates an exemplary desktop environment where a trend summary is represented by content being cycled in accordance with a desktop hotspot.

FIG. 5 illustrates a method in accordance with the disclosed architecture.

FIG. 6 illustrates an alternative method in accordance with the disclosed architecture.

FIG. 7 illustrates a block diagram of a computing system that executes summary generation from trending topics in accordance with the disclosed architecture.

### DETAILED DESCRIPTION

The disclosed architecture enables the extraction of content from content sources, which content summarizes a popular (or trending) topic at a given point in time. The summary is generated and based on a query submitted to a search engine. The architecture finds particular applicability to social networks that provide myriad topics in various content types (e.g., multimedia content of text, images, video, audio, links, etc.) and from which can be extracted content that when aggregated summarizes the trending topic for that given network, as related to the query.

The architecture can be applied, generally, to any network that exposes multimedia content, such as any social network for processing and content extraction. In other words, the architecture extracts pieces of content from social network activity, which content can effectively summarize a trending topic.

Presentation of the extracted content that characterizes the summary can be by way of a dynamic display which cycles through different types of content, such as trending photos, summarizing updates, and trending webpages. Moreover, the extracted content can be presented as a social “hotspot” (a viewable area of a program user interface (e.g., a bubble, pop-out) via which a user interacts, e.g., clicks, hovers, etc.) on a page or application environment which displays trending topics.

Three types of content include webpages, images, and social network updates. This content can be obtained in the following ways. With respect to webpages and images, a component of the architecture creates and stores the social network updates in an index, as enabled by access to a full stream of all social network updates. For example, publicly accessible updates can be received from social networks such as Facebook™ and Twitter™; however, the architecture is extensible to other social networks as well. Images most often detected in activity or posted by users in a given period of time are found and extracted. Social network updates may contain links to webpages. The most popular webpages are crawled and the summaries extracted from these most popular webpages.

When a trending topic is sent to the architecture as a query, the architecture queries the index and obtains a large number of updates relevant to the topic. Content items such as webpages and images, found among the updates, can be returned from the index and then ordered based on criteria that includes, but is not limited to, popularity, relevance to the query, quality of the content, etc. In one implementation, among all the documents which the index returns as being relevant, the media content is ordered by popularity, and then the top N instances of the popular content are returned. In any case, the top N items of each media type are then returned as the items which summarize the topic. For webpage content types, the architecture extracts the title of the webpage and a snippet of webpage information, which summarizes the content of the webpage that is relevant to the trending topic query.

With respect to summarizing updates, another component of the architecture consumes the updates received from the index for a given trending topic. On receiving these updates, the component applies a document summarizing algorithm to the collection of updates, thereby treating each update as a document. Algorithms that can summarize a collection of documents are well known.

The architecture also provides aggregated location activity such as check-in information from suitably available services, which record location-updates from users, are relevant to the query, and then display the location data in an aggregated fashion.

The extracted pieces of content can be shown inside a changing display, which cycles through the pieces of content, and pausing for a short period of time on each piece, for example. The display can be used as part of the search results (e.g., a web answer), in the desktop environment of an operating system (e.g., a tile in an operating system), and part of the content of a home page or news page.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

FIG. 1 illustrates a system 100 in accordance with the disclosed architecture. The system 100 depicts different social networks 102, where each of the networks 102 includes content types 104. The content types 104 can include text, images, video, audio, links to documents (e.g., webpages), and so on. Each of social networks 102 will typically have at least one trending topic (an item of interest to a group of users of the network that is dominant over other topics) that at any point in time will be the top popular topic; however, it can be the case that for a given point in time, a social network may not have any trending topic. The trending topic can be determined based on the interactive communications of the user as well as other activity of the social network (e.g., click activity, reading activity, authoring activity, etc.).

It can also be the case that the trending topic is not of a social network at all, but of the Internet, and/or other type of network from which topics can be obtained, analyzed, and processed for trends. Although this description focuses on trends obtained from social networks, or topics obtained from social networks to develop trending topics of the social networks, it is to be understood that topics or updates from social networks can be obtained and processed with other information to determine trending topics of the Internet, for example, or other networks. These trending topics can be computed based on many updates (e.g., social) occurring in a short period (span) of time (e.g., on one or more social networks) of a network.

Trending topics of a social network (the social networks 102) can be computed by the social network itself, and made available to (accessible by) an access component 106 (e.g., a suitably designed API or application) for further processing in accordance with the disclosed architecture. Alternatively, or in combination therewith, raw social network content (streaming) can be made accessible to the access component 106 to then perform trend analysis or hand this function off to another component.

While social network-derived trending topics may be useful in some ways, it is desirable that activity on social networks 102 be employed to augment query processing of a query 108 for searches performed by search engines, since existing techniques for augmenting search engine queries is currently ineffective or of little use to the user entering the query 108.

In one implementation, the disclosed architecture uses the search query 108 as input to the search engine and as “seed” data (the topic) for extracting the related trending topics from the social networks 102. Thus, not only are search results returned by the search engine, as commonly performed, but the search results are now augmented with the related trending topics from one or more of the social networks 102. Moreover, these trending topics related to the query 108 are summarized according to various content types.

For example, the trending topic (as related to the search query 108) of a first social network 110 can be summarized using only image content types, whereas the trending topic (as related to the search query 108) of a second social network 112 can be summarized using only text content types (e.g., “tweets” of the Twitter™ social network). Still further, the trending topic (as related to the search query) of a third social network 114 can be summarized using related webpage captions content types (where a caption is commonly-known a search result entry that includes a title, a brief web document summary, an image (optionally), a link to a web document, and a snippet of text).

It is within contemplation of the disclosed architecture; however, that a query is a necessary starting point. The access component 106 can also operate without a query input; then the summary algorithm 116 (or some other system) can identify the trending topics (which may in general not be related to a query), generate summaries for the trending topics and then show the summaries. This non-query method of operation can be useful in a desktop setting where the presentation system (component 120) rotates through the information of the topics that are trending at that time. In this case, the search query field 404 of FIG. 4 is not needed and can be omitted. Accordingly, the disclosed architecture operates with or without a query.

The trend summaries in the different content types and of the corresponding social networks 110, 112, and 114) are then presented, in a section of the webpage dedicated for such summaries. The section (or space) in the webpage is generated for these trend summaries, and can be of a fixed size to that the trend summaries do not consume too much webpage space, and have sufficient space to present the particular content types. Additionally, the summaries of the different content types can be cycled through this section of the webpage so the viewer can see the summaries.

Put another way, the system 100 includes the access component 106 that accesses a social network (e.g., the first social network 110) of the social networks 102 for content (and content types 104) related to a trending topic, as based on the query 108. A summary algorithm 116 selects a specific content type of the accessed content types 104 and creates a summary 118 of the trending topic using items of the specific content type. Thus, the trending topic can be summarized in one way as images from the first social network 110 and in another way as text from the second social network 112, or as an image summary and a text summary both from a single social network (e.g., the first social network 110).

The system 100 can also include a presentation component 120 that presents the items of the specific content type as the summary 118 of the trending topic of the social network(s). The summary 118 can be presented in a search engine results page along with search result returned for the query.

The access component 106 is associated with (part of or interfaces to) a search engine (not shown). The access component 106 accesses the content types 104 in response to processing of the query 108 by the search engine. The content of the content types is related to the query 108. The access component 106 accesses the content of the content types 104 of the social network (e.g., the first social network 110) and other social networks (e.g., the second social network 112 and the third social network 114). The summary algorithm 116 selects a specific content type (e.g., images) of the accessed content types 104 of the social network and other social networks and creates the summary 118 of the trending topic as obtained from the social network and other social networks using items of the specific content type.

The specific content type is one of related images or related webpages, and the trending topic is summarized by one of the related images or the related webpages. The presentation component 120 presents the summary 118 as one or more items of the specific content type as a rotating view of the items. In other words, while the summary 118 may be a single content type, such as an image, the summary 118 may comprise multiple items of images. In this latter case, the presentation component 120 can present multiple images of as the summary 118, and that are cycled through the summary space of the webpage. This is in contrast to rotating through different content types such as an image, text, webpage links, and then repeating the rotation beginning with the image, followed by the text, and so on.

The presentation component 120 can present the items of the specific content type in a search engine results page (SERP) in combination with search results relevant to the query 108 processed by the search engine.

A microprocessor can be configured to execute computer-executable instructions associated with at least one of the access component, the summary algorithm, or the presentation component.

FIG. 2 illustrates an alternative system 200 that further includes indexing and location activity processing. The system 200 includes the entities and components of system 100 of FIG. 1, and additionally, an indexing component 202 that creates an index 204 of social network updates obtained from the social network (e.g., the first social network 110) and other social networks (e.g., social networks 206), and the summary algorithm 116 searches the index 204 for updates relevant to the trending topic (as based on the query 108). The updates comprise different content types of the content relevant to the query 108, and as accessed and obtained from the social networks 102. The index 204 can be created as an offline process that crawls the social networks 102 based on queries being processed by the search engine and/or as a continuous realtime (processed in the timespan that the actual event is occurring) process that continually accesses and obtains trending content from the social networks 102 in response to queries being processed.

The access component 106 can access a check-in service 208 for check-in and check-out information related to geographical location activity of users. For example, when a user enters a business or other type of location that enables the capture of entry/exit information (e.g., restaurant credit card payment as check-out information, an entertainment event as check-in information, etc.), this check-in/check-out information can define a collection of users in a geographical area (e.g., downtown) for specific purpose (e.g., rock concert). This aggregation of location activity then defines a trend of activity. If the query 108 is “music in City X”, for example, the trend summary may include content (e.g., images) associated with the concert currently happening or about to happen downtown (City X). Thus, the geographical location activity relates to the trending topic.

Systems 100 and 200 can be cloud-based systems such that processing is performed predominantly in the cloud. In this implementation, the query 108 is submitted to the search engine and all subsequent processing is performed in the cloud. The summary 118 can then be passed to the presentation component 120, which can be a local browser or a web application, for presentation.

FIG. 3 illustrates an exemplary user interface 300 where a trend summary is represented by content being cycled in a search engine results page (SERP) 302. The SERP 302 includes a search query field 304 for entry and processing of a query, search results 306 related to the query, and other content 308, all of which can be commonly found in existing SERPs. However, in this implementation, the SERP 302 now includes a section 310 (annotated as “Social Ticker”) that presents the summary 118 of a current trending topic derived for one or more social networks. Here, the section 310 shows social network trend information of a first content type 312 (e.g., image) that represents the current trending topic (as seeded by the query). The summary 118 can be described according to different content types; thus, the summary 118 of the current trending topic can be described according to social network trend information of a second content type 314 (e.g., tweets) and social network trend information of a third content type 316 (e.g., web document links).

The presentation component 120 can be configured to cycle the content types 312, 314, and 316) through the section 310 based on a timed duration (e.g., two seconds) for presentation of each content type. Thus, the second content type 314 is moved into the section 310 after the time duration, and then replaced with the third content type 316 after another time duration expires. Note the content types 314 and 316 are illustrated outside the user interface 300 only for depicting the cycling process—all content types 312, 314, and 316) are not typically viewable at the same time, although this can be accommodated, if desired.

FIG. 4 illustrates an exemplary desktop environment 400 where a trend summary is represented by content being cycled in accordance with a desktop hotspot 402. The desktop environment 400 can include a search query field 404 for input of the query. The social network trend information (trend summaries) can then be rotated through the hotspot 402 according to a timed duration for each content type.

Here, the presentation component 120 can be configured to cycle the content types 312, 314, and 316) through the hotpot 402 based on the timed duration (e.g., two seconds) for presentation of each content type. Thus, the second content type 314 is moved into the hotpot 402 after the time duration expires for the first content type 312, and then replaced with the third content type 316 after another time duration expires. Note the content types 314 and 316 are illustrated outside the environment 400 only for depicting the cycling process—-all content types 312, 314, and 316) are not typically viewable at the same time, although this can be accommodated, if desired.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

FIG. 5 illustrates a method in accordance with the disclosed architecture. At 500, content types related to a trending topic of a social network can be accessed. The content types are part of the general content accessed from the social network. The general content can be related to a trending topic as the trending topic is relevant to the user query. At 502, a specific content type is selected from the content types. That is, the summary can be characterized or represented by a single content type such as images. At 504, a summary of the trending topic is created using the specific content type.

At 506, the summary is presented in a search results page. Alternatively, or in combination therewith, the summary can be presented in a desktop environment. If the user closes the SERP, the summary can be passed into the desktop hotspot for presentation. It can also be the case that the desktop environment includes a search query field, and if the query is processed from this desktop viewed query field, the summary is automatically passed into the desktop hotspot for presentation.

The method can further comprise accessing the content types of the social network in response to a query executed by a search engine. The method can further comprise presenting the summary as a specific content type in association with a related search result of a search results page. The method can further comprise accessing a trend summary of the social network and characterizing the trend summary using the specific content type.

The method can further comprise creating the summary using the specific content type, which specific content type is trending images, trending webpages, or summarizing updates. The method can further comprise presenting the summary, represented as multiple items of the specific content type, in a display that cycles presentation of the multiple items. The method can further comprise presenting the summary in response to interaction with a hotspot in a view.

FIG. 6 illustrates an alternative method in accordance with the disclosed architecture. At 600, a query is processed using a search engine. The query serves as “seed” data for obtaining related trending topic(s) from the Internet as a whole, from a user's immediate circle of friends and family, and/or social network of unknown and/or unknown users. At 602, content types (of content) related to a trending topic of social networks are accessed based on the query. It can be the case that the content is accessed and then the content types are extracted from the obtained content. At 604, a summary of the trending topic is created using content types. The summary of the trending topic can be characterized by a single content type such as text. At 606, the summary is presented for viewing.

The description has focused primarily on presentation on the larger computing systems; however, when implemented or accessed using smaller devices such as smart phones, the space for presenting the summary is more restrictive. Thus, it can be the case that the type of content can be the determining factor in what format the summary is presented. For example, given the more limited space in which to present the summary on a smartphone, it may be more desirable to use the summary characterized by text rather than the summary characterized by images.

The method can further comprise generating aggregated location activity content and including the aggregated location activity content in the summary. The method can further comprise presenting the summary in a desktop environment of a computing system. The method can further comprise presenting the summary in a home webpage or new webpage. The method can further comprise creating an index of the content types, ranking the content types by popularity, and selecting top ranked content types for the summary. In other words, only top ranked (most popular) images are utilized to characterize the summary using images. This approach can also apply to the other content types.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

Referring now to FIG. 7, there is illustrated a block diagram of a computing system 700 that executes summary generation from trending topics in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704 (also referred to as microprocessor(s) and processor(s)), a computer-readable storage medium such as a system memory 706 (computer readable storage medium/media also include magnetic disks, optical disks, solid state drives, external memory systems, and flash memory drives), and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 702 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 706 can include computer-readable storage (physical storage) medium such as a volatile (VOL) memory 710 (e.g., random access memory (RAM)) and a non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include entities and components of the system 100 of FIG. 1, entities and components of the system 200 of FIG. 2, entities and components of the user interface 300 of FIG. 3, entities and components of the desktop environment 400 of FIG. 4, and the methods represented by the flowcharts of FIGS. 5 and 6, for example.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) can be any available media (medium) that do (does) not employ propagated signals, can be accessed by the computer 702, and includes volatile and non-volatile internal and/or external media that is removable and/or non-removable. For the computer 702, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 702, programs, and data using external user input devices 728 such as a keyboard and a mouse, as well as by voice commands facilitated by speech recognition. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example.

These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an access component that accesses content types related to a trending topic;
a summary algorithm that selects a specific content type of the accessed content types and creates a summary of the trending topic using items of the specific content type;
a presentation component that presents the items of the specific content type as the summary of the trending topic; and
a microprocessor that executes computer-executable instructions associated with at least one of the access component, the summary algorithm, or the presentation component.

2. The system of claim 1, wherein the access component is associated with a search engine, the access component accesses the content types in response to processing of a query by the search engine, the content types related to the query.

3. The system of claim 1, wherein the access component accesses the content types of a social network and other social networks, and the summary algorithm selects a specific content type of the accessed content types of the social network and other social networks and creates a summary of the trending topic as obtained from the social network and other social networks using items of the specific content type.

4. The system of claim 1, wherein the specific content type is one of related images or related webpages, and the trending topic is summarized by one of the related images or the related webpages.

5. The system of claim 1, wherein the access component accesses a check-in service for check-in information related to geographical location activity of users, the geographical location activity related to the trending topic.

6. The system of claim 1, further comprising an indexing component that creates an index of social network updates obtained from a social network and other social networks, and the summary algorithm searches the index for updates relevant to the trending topic.

7. The system of claim 1, wherein the presentation component presents the items of the specific content type as a rotating view of the items.

8. The system of claim 1, wherein the presentation component presents the items of the specific content type in a search results page in combination with search results relevant to a query processed by a search engine.

9. A method performed by a computer system executing machine-readable instructions, the method comprising acts of:
accessing content types related to a trending topic of a social network;
selecting a specific content type from the content types;
creating a summary of the trending topic using the specific content type;
presenting the summary in a search results page; and
configuring a microprocessor to execute instructions in a memory associated with at least one of the acts of accessing, selecting, creating, or presenting.

10. The method of claim 9, further comprising accessing the content types of the social network in response to a query executed by a search engine.

11. The method of claim 9, further comprising presenting the summary as a specific content type in association with a related search result of a search results page.

12. The method of claim 9, further comprising accessing a trend summary of the social network and characterizing the trend summary using the specific content type.

13. The method of claim 9, further comprising creating the summary using the specific content type, which specific content type is trending images, trending webpages, or summarizing updates.

14. The method of claim 9, further comprising presenting the summary, represented as multiple items of the specific content type, in a display that cycles presentation of the multiple items.

15. The method of claim 9, further comprising presenting the summary in response to interaction with a hotspot in a view.

16. A method performed by a computer system executing machine-readable instructions, the method comprising acts of:
processing a query using a search engine;
accessing content types related to a trending topic of social networks based on the query;
creating a summary of the trending topic using content types;
presenting the summary for viewing; and
configuring a microprocessor to execute instructions in a memory associated with at least one of the acts of processing, accessing, creating, or presenting.

17. The method of claim 16, further comprising generating aggregated location activity content and including the aggregated location activity content in the summary.

18. The method of claim 16, further comprising presenting the summary in a desktop environment of a computing system.

19. The method of claim 16, further comprising presenting the summary in a home webpage or new webpage.

20. The method of claim 16, further comprising creating an index of the content types, ranking the content types by popularity, and selecting top ranked content types for the summary.
